(19) United States
(12) Patent Application Publication
(10) Pub. No.: US 2013/0108134 A1
(43) Pub. Date: May 2, 2013

(54) METHOD FOR PELVIC IMAGE ANALYSIS

(71) Applicant: Hui Luo, Pittsford, NY (US)

(72) Inventor: Hui Luo, Pittsford, NY (US)

(21) Appl. No.: 13/281,577

(22) Filed: Oct. 26, 2011

(51) Int. Cl. G06K 9/00

(52) U.S. Cl. 382/132

(57) ABSTRACT

A method for obtaining information about a patient's anatomy from a radiography image. The method includes positioning one or more anatomy models with respect to image features, with the image in a predetermined orientation. One or more search regions within the image is defined according to the one or more positioned anatomy models. One or more anatomy feature points are detected and displayed in the radiography image according to search results from within the one or more defined search regions.

### FIELD OF THE INVENTION

The invention relates generally to the field of medical imaging and more particularly to a method for identifying features in full-spine x-ray and pelvic radiographic images and obtaining measurements therefrom.

### BACKGROUND OF THE INVENTION

Among tools used by chiropractors to quantify the condition of the lower spine and pelvis are utilities such as the Gonstead technique. The Gonstead Technique is a highly effective, full spine technique of chiropractic science that helps to locate misalignment of the spine and other problems that may cause various types of nerve irritation and pain. Using Gonstead analysis helps to identify disease processes, fractures, vertebral misalignments, and other conditions, and to evaluate posture, joint, and disc integrity.

To use the Gonstead analysis in conventional chiropractic procedure, X-rays of the full spine and pelvis are employed to obtain a series of measurements that allow the practitioner to visualize and evaluate the entire spine, sacrum and pelvic region. Features are identified from the x-rays and measurements related to these features are obtained and used in patient assessment. Features are located manually, by careful examination and marking of the x-ray film. Similarly, measurements between features are also made manually. The task of marking up the x-ray film and making correct measurements between marked features is time-consuming and error-prone. Moreover, repeatability can be a problem, since results for the same patient can differ from one practitioner to the next.

Thus, there is a need for a computer-aided utility for identifying anatomical features and generating measurements suitable for Gonstead analysis and similar assessment of anatomical features.

### SUMMARY OF THE INVENTION

Embodiments of the present invention advance the art of medical imaging by providing improved methods for assessment of anatomical structures used in Gonstead pelvic analysis and other techniques. A sequence of image processing steps is used to mark and measure the x-ray image for use by the medical practitioner.

An advantage of the present invention is the use of automated techniques that can be guided by the practitioner to provide useful information for Gonstead pelvic analysis and other methods.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for obtaining measurement information about a patient's anatomy from a radiography image. The method comprises: positioning one or more anatomy models with respect to image features, with the image in a predetermined orientation; defining one or more search regions within the image according to the one or more positioned anatomy models; and detecting and displaying one or more anatomy feature points in the radiography image according to search results from within the one or more defined search regions.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a plan view that shows points identified when using the Gonstead procedure.

FIG. 2 is a logic flow diagram that shows the steps used to obtain and display feature points for Gonstead analysis according to an embodiment of the present invention.

FIGS. 3A and 3B show, respectively, an original x-ray image and an edge-enhanced processed version.

FIG. 4 shows a composite image formed from a set of anatomy models overlaid onto an edge image.

FIG. 5 shows exemplary measurements made to check for the relative spatial relationships of the located models.

FIG. 6 shows a number of search regions defined in a pelvic image.

FIG. 7 shows an imaging system with display that provides an image for operator/practitioner viewing as well as for instruction entry according to an embodiment of the present invention.

FIG. 8 is a plan view that shows an operator adjustment of detected image features.

### DETAILED DESCRIPTION OF THE INVENTION

The following is a detailed description of the preferred embodiments of the invention, reference being made to the drawings in which the same reference numerals identify the same elements of structure in each of the several figures.

In the context of the present disclosure, it should be understood that ordinal terms such as “first”, “second”, and “third”, and so on do not necessarily connote any priority, precedence, or order of one element or process over another, or the temporal order in which acts of a method are performed, but are used merely as labels to distinguish one claim element having a certain name from another element having a same name (but for use of the ordinal term) to distinguish the claim elements.

The term “highlighting” for a displayed feature has its conventional meaning as is understood to those skilled in the information and image display arts. In general, highlighting uses some form of localized display enhancement to attract the attention of the viewer. Highlighting a portion of an image, such as an individual organ, bone, or structure, or a path from one chamber to the next, for example, can be achieved in any of a number of ways, including, but not limited to, annotating, displaying a nearby or overlaying symbol, outlining or tracing, display in a different color or at a markedly different intensity or gray scale value than other image or information content, blinking or animation of a portion of a display, or display at higher sharpness or contrast.

Gonstead pelvic image analysis employs a well-defined sequence of steps for identifying and marking a number of particular features on the x-ray film. Once these points are located, subsequent steps generate lines and make various measurements that aid the practitioner in quantifying various aspects of patient condition.

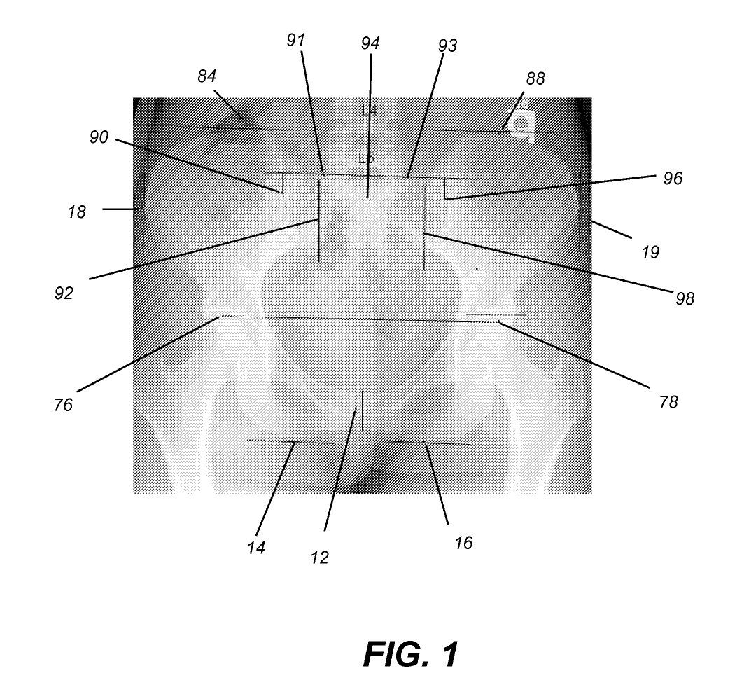

FIG. 1 shows points that are generally identified when following the Gonstead procedure. This procedure identifies two femur head points 76 and 78. Three points 12, 14, and 16 are then identified at the symphysis pubis and at the bottom of each ischial tuberosity, respectively. Next, points 84 and 88 on the left and right iliac crest are identified, along with points 18 and 19 on the most lateral aspect of the iliac wing. Finally, given the framework defined by points along the exterior, a point 94 is located at the center of S2 tubercle, and two points on the lateral aspect of S1, 91 and 93, are identified. A point on the most lateral aspect of the right sacral wing 90 and a point on the most lateral aspect of the left sacral wing 96 are identified. Two points on the most medial aspect of posterior superior iliac spine 92 and 98 are identified. With the points shown in FIG. 1 and described herein are identified, a number of lines can be drawn, as shown, so that measurements can be obtained. Measurements can include, for example, dimensions and distances, information about whether or not lines between different sets of points are in parallel, and other useful data indicating dimensional and placement relationships.

Embodiments of the present invention utilize various image processing techniques and tools to perform the initial point identification in an automated manner. Interactive utilities enable the viewing practitioner or other type of operator to verify correct point locations as well as to edit the automated results. In addition, image analysis tools then allow straightforward dimensional measurement and reporting of results to be displayed to the operator.

There is provided a workflow used for point-by-point anatomy identification and measurement in Gonstead analysis. One sequence proceeds as follows:

(1) Identify the 5 lumbar vertebrae, L1, L2, L3, L4, and L5.

(2) Identify the highest points or head points on the right and left femur.

(3) Connect the head points to form the femoral head line.

(4) Identify the highest points on right and left iliac crests and lowest points on the right and left ischial tuberosity.

(5) Construct lines parallel to the femoral head line through the added points in step (4).

(6) Measure distances between iliac crest lines and ischial tuberosity lines. These measurements are made perpendicular to lines constructed in step (5).

(7) Identify points on the S2 (or S1) tubercle and in the center of the pubic symphysis.

(8) Construct a line perpendicular to the femoral head line and pointing through the Si tubercle.

(9) Measure the distance between line constructed in step (8) and the pubic symphysis point.

(10) Locate a point at the lateral aspect of each S1 facet base and construct a line through these points to form a sacral base line.

(11) Identify points on the most lateral aspects of the right and left sacral wing.

(12) Extend lines perpendicular to the femur head line from these points to the sacral base line. Measure the distance between intersections.

(13) Calculate the measured deficiency (M.D.) For this purpose, a line is extended horizontally from the most superior aspect of the two femur heads and above the lower femur head line. The true vertical distance from the femur head line gives a measurement of measured deficiency.

(14) Identify a point at the most lateral aspect of the right iliac wing and another point on the most medial aspect of the posterior superior iliac spine. Construct lines perpendicular to the femur head line through these added points and measure the perpendicular distance between these lines. Repeat this process for the left side.

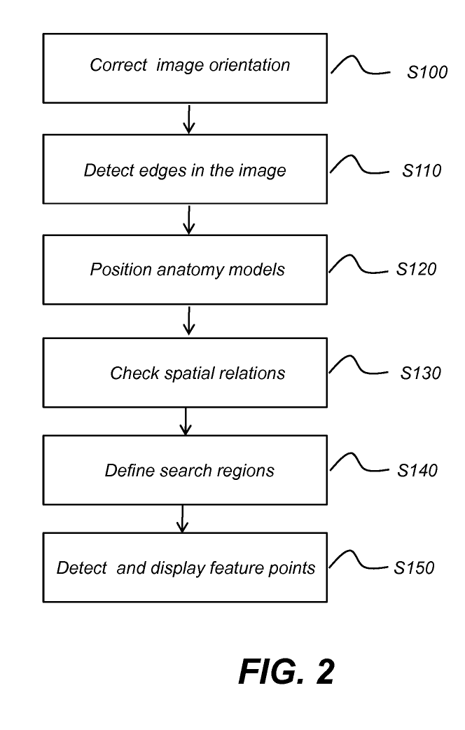

Consistent with described embodiments, the logic flow diagram of FIG. 2 shows a sequence of steps used to carry out the above sequence and obtain and display the feature points described with reference to FIG. 1. In an orientation step S100, image orientation is checked and, if adjustment is needed, corrected in order to prepare the image data for subsequent processing. Methods for detecting and correcting image orientation are known to those skilled in the medical imaging arts. One example of a method for orientation correction is described, for example, in commonly assigned U.S. Pat. No. 7,519,207 entitled “Detection and Correction method for radiograph orientation” to Luo et al.

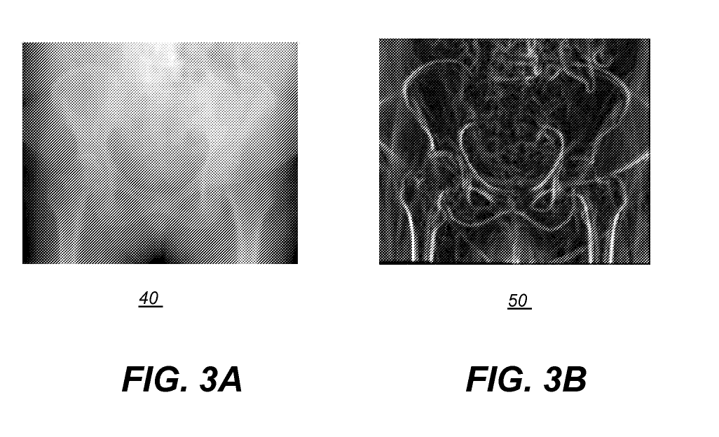

Continuing with the sequence of FIG. 2, an edge detection step S110 follows, processing the properly oriented image in order to detect and highlight edge features. Edge detection can be executed in any of a number of ways. Referring to FIGS. 3A and 3B, there is shown an original x-ray image 40 and its corresponding processed edge image 50. Edges in image 50 are obtained by applying edge detection operators to the original image data of image 40. A number of different types of edge detection or edge-enhancement operators can be used for generating the edge images. Sobel filters are one type of edge-enhancement mechanism that can be used to provide the edges in processed image 50. It must be emphasized that embodiments of the present invention are not limited to require the generation and use of edge images. Any image that can be used for detection of edge anatomy in a pelvic image can be suitable as processed edge image 50 for the present invention.

Continuing with the processing sequence of FIG. 2, a model positioning step S120 is executed using the processed edge image 50 (FIG. 3B) obtained from step S110 or other image that is suitable for use in edge analysis. The model positioning step S120 overlays each of a set of models onto processed edge image 50 to find a suitable fit of the model to the edge image 50 data. Model location and positioning techniques are well known and operate by testing the model position against a number of nearby positions, optimizing model positioning until a computed correlation value approaches an optimal or “best-fit” value.

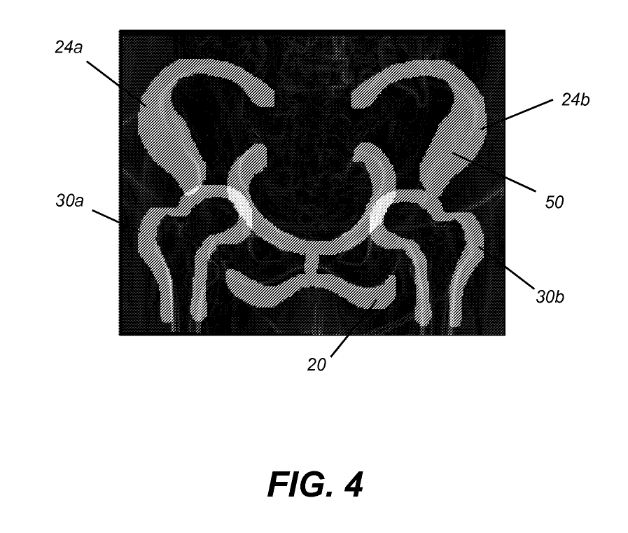

The models that are used are previously defined, having been developed by edge analysis of different patients of different types having different sizes, for example. Edge contours of the models are enlarged to accommodate different patient types. In one embodiment of the present invention, there are five anatomy models that can be individually applied and combined: two iliac wing models, a pubic bone model and two femur head models. The composite image of FIG. 4 shows these models combined and arranged in position with respect to the edge image in step S120. A preferred match location is determined by the highest correlation position computed between the model and the edges in the search region. In order to accommodate differences in patient size and other variables, the model contours are enlarged, as shown in FIG. 4. In addition to overlay positioning, the model size and orientation can also be adjusted to achieve a preferred match.

FIG. 4 shows, for an exemplary embodiment, how models are overlaid onto processed edge image 50 and positioned according to an embodiment of the present invention. As noted previously, five models are used in this exemplary embodiment, although more or fewer models could be used. Initially, a pubic bone model 20 is positioned with respect to edge image 50, centered about the corresponding region in edge image 50. Given this reference, one or both iliac wing models 24a and 24b can then be placed, preferably centering the edge image within the model as well as possible. Left and right femur head models 30a and 30b are then located in position.

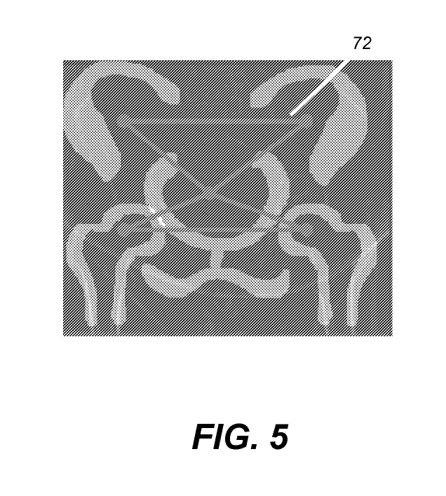

Referring to FIG. 5, a check spatial relations step S130 (FIG. 2) checks geometry 72 of the spatial relationships of the models as a validation step. In the present invention, the geometric relationships of models are derived from a set of training images. Geometric relationships can be modeled into a graphic model; alternately, measurable values such as the distances between specific points, distances between lines constructed between points, symmetry, areas subtended by a triangle or other polygon bounded according to specified points and connecting lines, and other values can be used as checks for validating how well the anatomy model is positioned. Step S130 is of particular interest because it provides a measure of how model locations satisfy the required anatomical structure relations. Where measured geometry differs significantly from expected anatomical relationships, the model or model positioning is a poor match for the target anatomical structure in the image. In such case, validation is considered poor and an adjustment can be made to improve the match. One useful method to achieve a better match is to define a new search region for the mismatched model. This new region can be derived from the geometric relationship of the model and other matched models. Checks of spatial relation for this validation process can be achieved using various methods known to those skilled in the image analysis arts, such as graphic matching, for example.

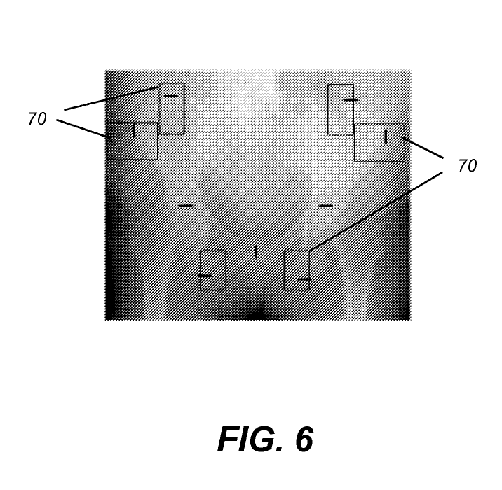

Continuing with the sequence of FIG. 2, a search region definition step S140 defines an appropriate search region based on the positioned models of step S120. FIG. 6 shows search regions 70 defined in the image. Search regions 70 help to delimit the portion of the image over which subsequent detection algorithms must operate. At the conclusion of this processing, the desired features are defined and displayed in a feature points detection and display step S150. The detection of features can be achieved by using both edge analysis and image intensity, for example.

An exemplary embodiment of the present invention employs the sequence described in FIG. 2 in an automated manner, without input or instructions from the practitioner or other operator. However, it can be appreciated that practitioners can find it useful to be able to preview and to adjust the results of automated processing or to refine processing by “marking” the displayed image to indicate positions of features of interest.

### Accepting Operator Instructions and Input

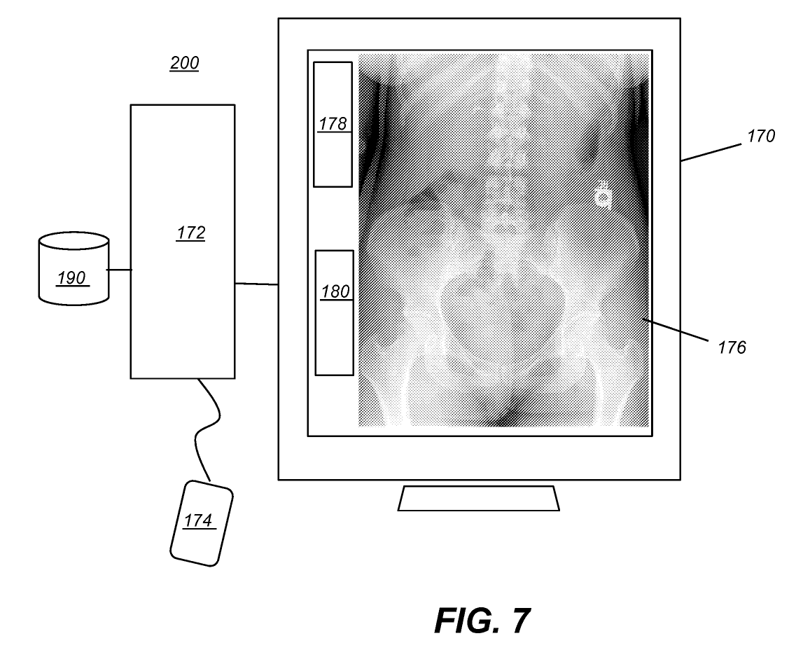

According to at least one embodiment of the present invention, the operator enters one or more instructions or other input prior to, during, or following execution of processing for Gonstead analysis or other analysis, such as that processing described with reference to FIG. 2. FIG. 7 shows an imaging system 200 having a display 170 that provides an image 176 for operator/practitioner viewing as well as for instruction entry. A computer 172 is in signal communication with display 170 and is also in signal communication with one or more instruction entry devices 174 for operator entry, which can include a keyboard, a mouse or other manual pointer, or an audio input or gaze-tracking input apparatus. Instructions can be entered by a set of menus or other graphical user interface (GUI) features, part of an on-screen instruction entry area 178. An optional patient information area 180 provides additional identifying information about the patient, about imaging conditions, and other useful information. A computer-accessible memory 190 can provide extra buffer space for calculation and can be used for image processing and results storage.

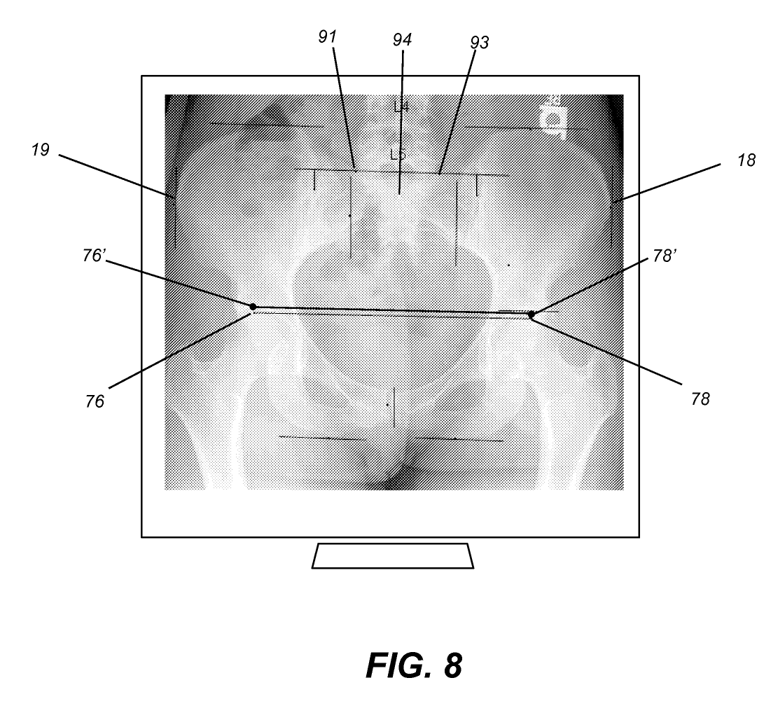

For the Gonstead analysis sequence described previously, a succession of operator interface screens and prompts are displayed in a sequence that shows the results of each processing step and, at each step, guides the operator by indicating what information can be entered or modified as a next step. By way of example, the plan view of FIG. 8 shows display 170 that displays results of automated processing to identify image features and allows the operator to adjust feature positions. Femur head points 76 and 78 are shifted upward slightly by the operator in this example, using a mouse or other pointer, to corresponding femur head points 76′ and 78′.

It is noted that there can be some dependencies between point locations. Because of this, shifting the positions of one or more points that define outer or boundary features also recalculates and adjusts the positions of points that lie within bounded portions of the image. In the example of FIG. 8, adjusting iliac bone lateral points 18 and 19 can cause recalculation and repositioning of points 91 and 93 in the displayed image.

The operator interface provides a number of useful utilities for operator entry and adjustment of points and other geometric features, for image enhancement, and for obtaining measurement data that can be of value for analysis of the patient. Utilities include:

(i) Capability to position and re-position points. Where points of interest are detected using an automated process, as described previously, the operator has the option of reviewing points placement and manually adjusting this placement accordingly. Various operator interface tools are available to allow coarse and fine adjustment of point position. As operator adjustments are made, feature points that are associated with the re-positioned points are automatically adjusted accordingly.

(ii) Capability to select points or lines, highlight them on the display, and use this information to instruct the system about these features.

(iii) Capability to obtain distance between points or between lines. For example, the operator may desire to verify a measurement or obtain some non-standard measurement between points. Consistent with an embodiment of the present invention, a utility is provided that indicates, in response to a viewer command, the distance between any two points or other geometric constructions formed on the displayed image.

(iv) Capability to step through the processing one operation at a time, allowing the viewer to sequence through processing results for monitoring the progress of the overall analysis.

(v) Color and animated display capability. This can be useful for line and point placement. According to at least one embodiment of the present invention, the viewer clicks/selects a point or line and makes a color selection.

(vi) Text annotation, either directly overlaid on the image or linked to the image in a readily accessed manner. This can include audio message annotation, so that a recorded comment, statement, or other observation can be coupled to the image, such as in a file header or by an electronic link or address, for example, and can be accessible to the viewer of an image.

(vii) Zoom, crop, pan, and related image viewing utilities.

(viii) Guided sequence with operator prompts. For standard Gonstead analysis, for example, a script can be executed prompting the operator for each step in the process and offering options for processing operation. According to an embodiment of the present invention, prompting is done following a specific point identification sequence. The operator or practitioner responds to blinking points on the display that indicate calculated points, such as those described with reference to FIG. 8. The operator can verify these points or interact with the display to reposition them. When the points are properly located, an operator instruction moves on to define the next points in sequence. Where boundary points are shifted in position, recalculation is performed to adjust the corresponding positions of related points that are positioned relative to boundary points.

(ix) Image enhancement tools, such as utilities that improve image contrast or edge detection.

(x) Storage of the processed image in memory, such as for later access and review, for example.

(xi) Capability to track the patient's improvement after chiropractic treatment, to compare patient condition before and after treatment on appropriate images, and to measure and display difference values on both images or both differences on the improved image. The display of results allows the practitioner and patient to view progress of ongoing treatment, for example.

(xii) Capability to generate a standard chiropractic report from the image results, including measurement results and image evaluation results.

(xiii) Capability to generate a patient central display that includes stored images, overlay measurement results, and improvement results. This capability further allows the user to obtain a hard copy of results, one or more images, and information for future reference.

Consistent with at least one embodiment of the present invention, a computer executes a program with stored instructions that perform on image data accessed from an electronic memory. As can be appreciated by those skilled in the image processing arts, a computer program of an embodiment of the present invention can be utilized by a suitable, general-purpose computer system, such as a personal computer or workstation. However, other types of computer systems can be used to execute the computer program of the present invention, including networked processors. The computer program for performing the method of the present invention may be stored in a computer readable storage medium. This medium may comprise, for example; magnetic storage media such as a magnetic disk (such as a hard drive) or magnetic tape or other portable type of magnetic disk; optical storage media such as an optical disc, optical tape, or machine readable bar code; solid state electronic storage devices such as random access memory (RAM), or read only memory (ROM); or any other physical device or medium employed to store a computer program. The computer program for performing the method of the present invention may also be stored on computer readable storage medium that is connected to the image processor by way of the internet or other communication medium. Those skilled in the art will recognize that the equivalent of such a computer program product may also be constructed in hardware.

It will be understood that the computer program product of the present invention may make use of various image manipulation algorithms and processes that are well known. It will be further understood that the computer program product embodiment of the present invention may embody algorithms and processes not specifically shown or described herein that are useful for implementation. Such algorithms and processes may include conventional utilities that are within the ordinary skill of the image processing arts. Additional aspects of such algorithms and systems, and hardware and/or software for producing and otherwise processing the images or co-operating with the computer program product of the present invention, are not specifically shown or described herein and may be selected from such algorithms, systems, hardware, components and elements known in the art.

It is noted that the term “memory”, equivalent to “computer-accessible memory” in the context of the present disclosure, can refer to any type of temporary or more enduring data storage workspace used for storing and operating upon image data and accessible to a computer system. The memory could be non-volatile, using, for example, a long-term storage medium such as magnetic or optical storage. Alternately, the memory could be of a more volatile nature, using an electronic circuit, such as random-access memory (RAM) that is used as a temporary buffer or workspace by a microprocessor or other control logic processor device. Display data, for example, is typically stored in a temporary storage buffer that is directly associated with a display device and is periodically refreshed as needed in order to provide displayed data. This temporary storage buffer can also be considered to be a memory, as the term is used in the present disclosure. Memory is also used as the data workspace for executing and storing intermediate and final results of calculations and other processing. Computer-accessible memory can be volatile, non-volatile, or a hybrid combination of volatile and non-volatile types. Computer-accessible memory of various types is provided on different components throughout the system for storing, processing, transferring, and displaying data, and for other functions.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A method for obtaining information about a patient's anatomy from a radiography image, comprising:
positioning one or more anatomy models with respect to image features, with the image in a predetermined orientation;
defining one or more search regions within the image according to the one or more positioned anatomy models;
detecting one or more anatomy feature points in the radiography image according to search results from within the one or more defined search regions; and
displaying the one of more anatomy feature points.

2. The method of claim 1 wherein the one or more positioned anatomy models comprise one or more of an iliac wing model, a pubic bone model, and a femur head model.

3. The method of claim 1 wherein positioning the one or more anatomy models comprises overlaying the one or more anatomy models with respect to the radiography image.

4. The method of claim 1 further comprising verifying the positioning of the anatomy models according to spatial relationships of two or more detected image features.

5. The method of claim 1 wherein the one or more positioned anatomy models are generated using statistical data from a plurality of patients.

6. The method of claim 1 further comprising forming an edge-enhanced image from the radiography image.

7. The method of claim 1 further comprising adjusting the position of one or more of the displayed anatomy feature points in response to an operator instruction.

8. The method of claim 1 further comprising re-orienting the image to the predetermined orientation.

9. The method of claim 1 further comprising constructing one or more lines over the image, wherein the lines connect two or more of the anatomy feature points.

10. A method for obtaining information about a patient from a radiographic image of the pelvic region, comprising:
orienting the radiographic image to a predetermined orientation;
forming an edge-enhanced image from the oriented image;
positioning one or more anatomy models with respect to the edge-enhanced image;
validating spatial relationships of the positioned one or more anatomy models according to measurements from the anatomy model positioning;
defining one or more search regions in the image according to the positioned anatomy models;
detecting one or more anatomy feature points in the radiography image according to search results within the one or more defined search regions;
measuring one or more distances relative to the detected feature points; and
displaying the measured distances on the image.

11. The method of claim 10 wherein the anatomy models are formed using statistical data from a plurality of patients.

12. The method of claim 10 wherein defining the one or more search regions comprises accepting operator instructions that specify locations of anatomical features in the radiography image.

13. The method of claim 10 further comprising constructing one or more lines over the image according to the one or more detected anatomy feature points.

14. The method of claim 10 wherein validating the spatial relationships comprises at least one of computing a distance between at least two anatomy feature points and computing an area bounded by three or more anatomy feature points.

15. The method of claim 10 wherein detecting the one or more anatomy feature points in the radiography image further comprises executing a Gonstead analysis sequence.

16. The method of claim 10 further comprising recording an observation from the operator and coupling the recorded observation to the displayed image.

17. The method of claim 16 wherein the recorded observation is an audio message.

18. The method of claim 10 further comprising prompting the user to reposition the one or more anatomy feature points in the displayed image.

19. The method of claim 18 further comprising recalculating other anatomy feature points according to the repositioned one or more anatomy feature points.

20. The method of claim 10 further comprising generating a report according to the one or more measured distances.
